(19) United States
(12) Patent Application Publication
(10) Pub. No.: US 2024/0136551 A1
(43) Pub. Date: Apr. 25, 2024

(54) GRAVITY DRAINAGE SUBSYSTEM FOR REDOX FLOW BATTERY SYSTEM

(71) Applicant: ESS TECH, INC., Wilsonville, OR (US)

(72) Inventors: Joseph Michael Cooley, Beaverton, OR (US); Yang Song, West Linn, OR (US)

(21) Appl. No.: 18/465,841

(22) Filed: Sep. 11, 2023

Related U.S. Application Data
(60) Provisional application No. 63/380,197, filed on Oct. 19, 2022.

(51) Int. Cl. H01M 8/04276; F16K 11/00; H01M 8/0289; H01M 8/043; H01M 8/04746; H01M 8/18

(52) U.S. Cl. CPC H01M 8/04276; F16K 11/00; H01M 8/0289; H01M 8/043; H01M 8/04746; H01M 8/188

(57) ABSTRACT

Systems and methods are provided for a redox flow battery system. In one example, the redox flow battery system includes an electrolyte sump tank positioned below cell stacks of the redox flow battery system. The electrolyte sump tank may be configured to receive electrolyte from the cell stacks during operation of the redox flow battery system in a stand-by mode. The redox flow battery system may further include three-way valves arranged in a flow path of the electrolyte between the cell stacks and the electrolyte sump tank to control a flow of the electrolyte to the electrolyte sump tank.

### CROSS REFERENCE TO RELATED APPLICATIONS

The present application claims priority to U.S. Provisional Application No. 63/380,197 entitled “GRAVITY DRAINAGE SUBSYSTEM FOR REDOX FLOW BATTERY SYSTEM”, filed Oct. 19, 2022. The entire contents of the above identified application is hereby incorporated by reference for all purposes.

### FIELD

The present description relates generally to a redox flow battery system.

### BACKGROUND AND SUMMARY

Redox flow batteries are suitable for grid scale storage applications due to their capability for scaling power and capacity independently, as well as for charging and discharging over thousands of cycles with reduced performance losses in comparison to conventional battery technologies. Iron hybrid redox flow batteries are particularly attractive due to the incorporation of low cost materials in the cell stack. The iron redox flow battery (IFB) relies on iron, salt, and water for electrolyte, where a composition of the electrolyte is the same for a negative electrolyte and a positive electrolyte of the IFB.

During operation of the IFB, the electrolyte may be circulated therethrough, flowing across plates of cell stacks of the IFB. As the electrolyte may be an acidic medium in order to maintain a solubility of its active materials, such as iron compounds, submerging of the plates in the electrolyte when electrolyte flow is halted may lead to degradation of the cell stack plates. For example, during operation in a stand-by mode, electrolyte pumps may be deactivated, thereby suspending circulation of the electrolyte. In some examples, in response to the IFB operating in the stand-by mode, a drain pump may be electrically activated to drain the cell stacks of the electrolyte in order to mitigate degradation caused by of prolonged immersion of the plates in stagnant acid.

By pumping the electrolyte out of the cell stacks during operation of the IFB in the stand-by mode, a useful life of IFB components may be prolonged. However, the inventors herein have recognized issues with relying on the drain pump for draining the IFB cell stacks when the IFB is operating in the stand-by mode. As one example, if an episode of system power loss occurs, the drain pump may not be able to drain the IFB cell stacks unless an uninterruptible power supply (UPS) is included in the IFB. In order to provide sufficient power to operate the drain pump, the UPS may be large which may increase a footprint and a cost of the IFB. Furthermore, if the UPS becomes degraded and unable to provide backup power to operate the drain pump, the electrolyte may not be removed from the cell stacks, leading to adverse effects on an integrity of the IFB components.

As one example, the issues described above may be at least partially mitigated by a redox flow battery system having an electrolyte sump tank positioned below cell stacks of the redox flow battery system, the electrolyte sump tank configured to receive electrolyte from the cell stacks during operation of the redox flow battery system in a stand-by mode. The redox flow battery system may further include three-way valves arranged in a flow path of the electrolyte between the cell stacks and the electrolyte sump tank to control a flow of the electrolyte to the electrolyte sump tank. In this way, the electrolyte may be drained from the battery cell stacks during operation in the stand-by mode via a strategy that is robust even during instances of power loss.

For example, the three-way valves may be adjusted between a first position that causes the electrolyte flow to bypass the electrolyte sump tank, and a second position that fluidically couples the electrolyte sump tank to the cell stacks. By locating the electrolyte sump tank below the cell stacks and adjusting the three-way valves to the second position, the electrolyte may be compelled by gravity to drain out of the cell stacks and into the electrolyte sump tank. Upon subsequent operation of the redox flow battery system in a charge or discharge mode, the three-way valves may be adjusted to the first position in a staggered manner to allow the electrolyte sump tank to be emptied of the electrolyte. As such, degradation of components of the cell stacks, such as bipolar plates, may be reduced without demanding use of additional pumping devices or relying on a large UPS to provide backup power.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system which may be adapted with a gravity drainage subsystem.

FIG. 2 shows an example of a layout of the redox flow battery system of FIG. 1.

FIG. 3 shows a first example of a configuration of a redox flow battery system having a gravity drainage subsystem.

FIG. 4 shows a second example of a configuration of a redox flow battery system having a gravity drainage subsystem.

FIG. 5 shows an example of a method for operating a redox flow battery system having a gravity drainage subsystem.

FIG. 6 shows examples of variations in operating parameters of a redox flow battery system having a gravity drainage subsystem.

### DETAILED DESCRIPTION

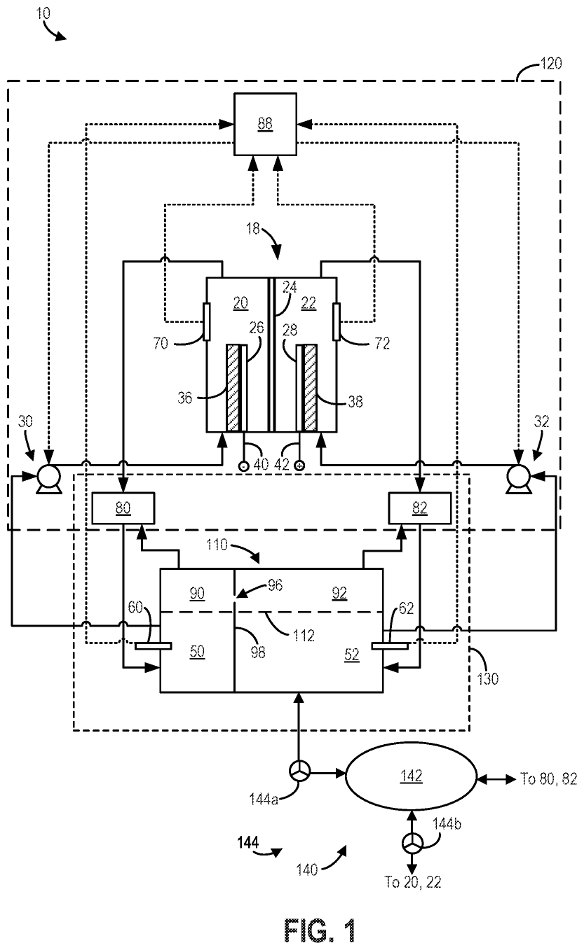

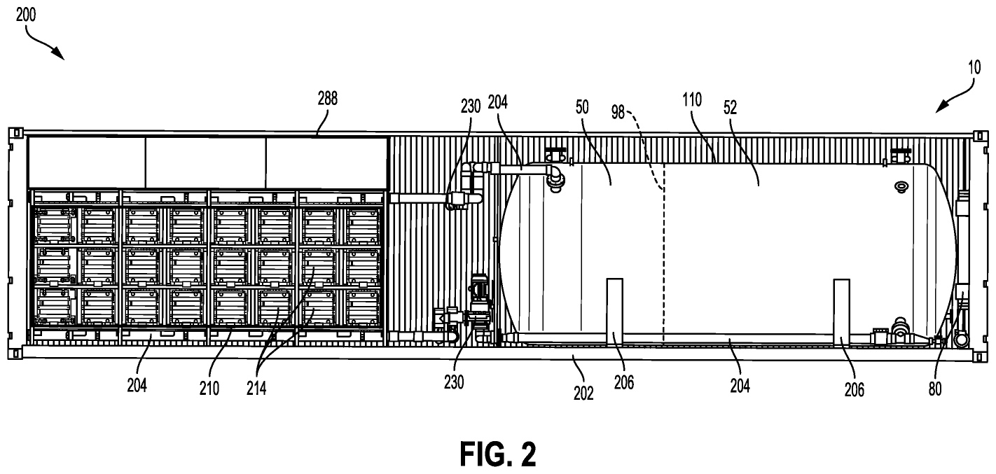

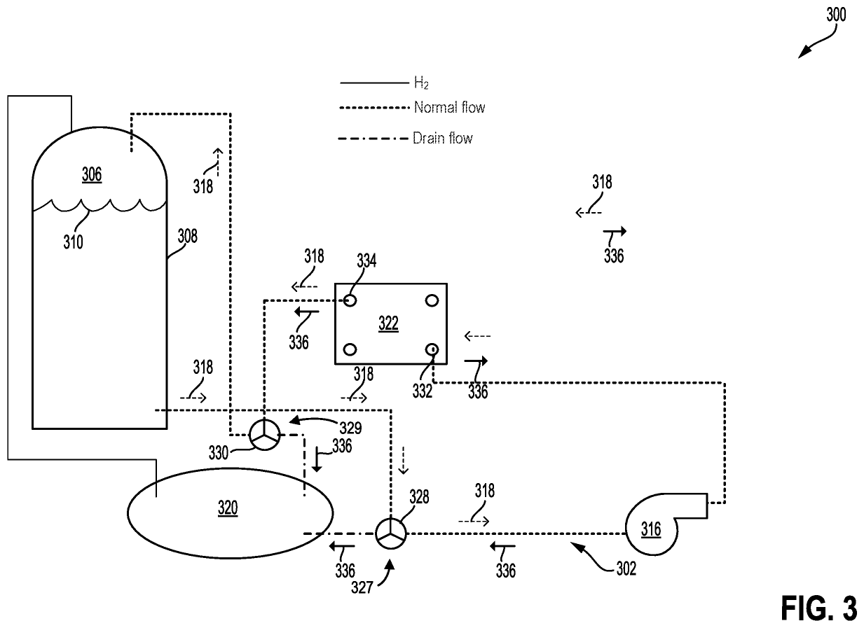

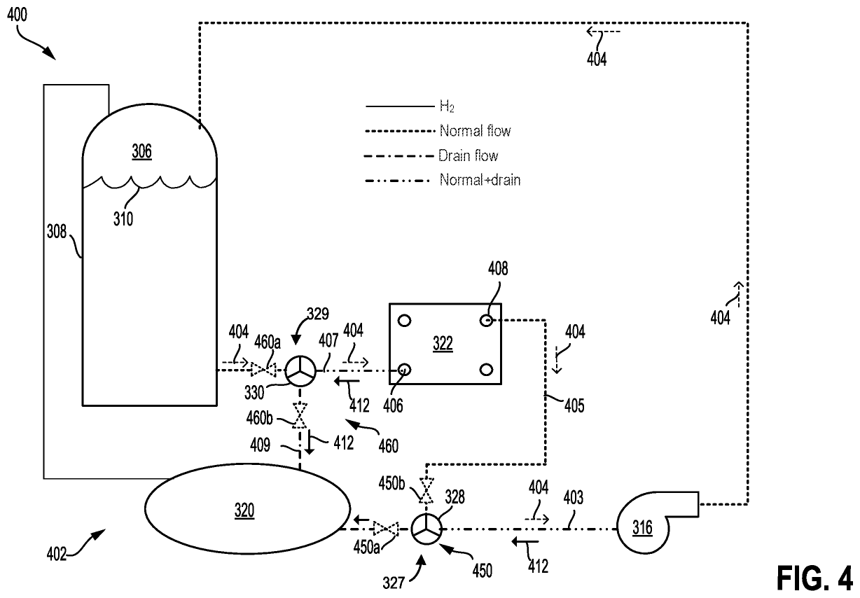

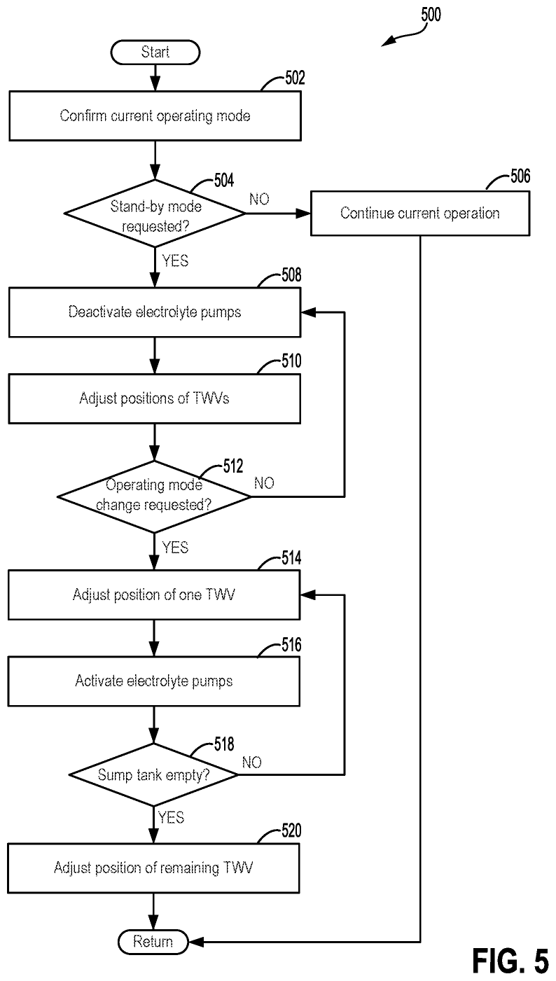

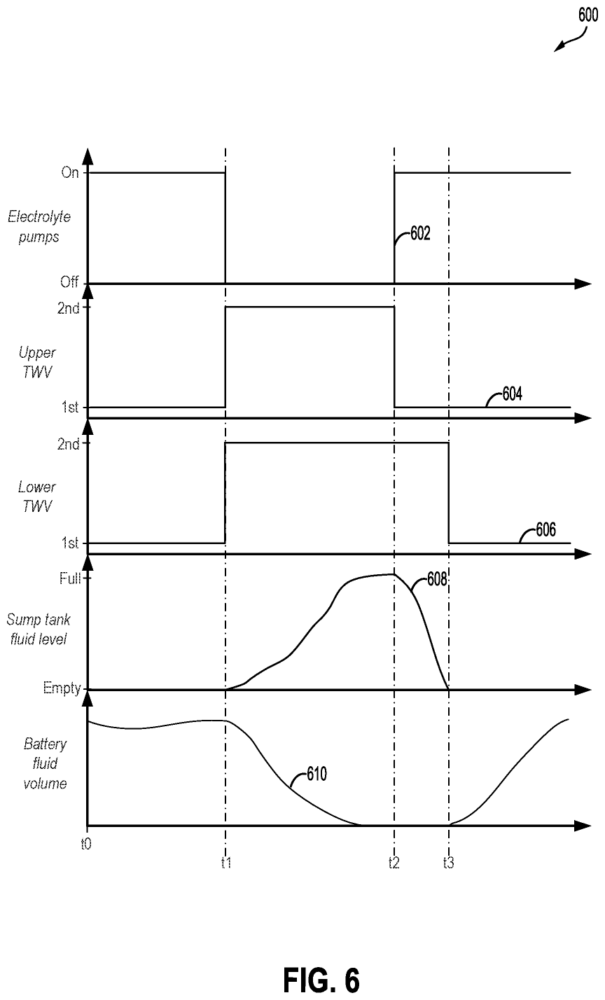

The following description relates to a gravity drainage subsystem for a redox flow battery system. In one example, the redox flow battery system may include an iron redox flow battery (IFB). The redox flow battery system, as illustrated schematically in FIG. 1, may rely on an electrolyte subsystem that circulates electrolyte through cell stacks of the system, where the cell stacks are depicted in FIG. 2, in a diagram showing an exemplary layout of the redox flow battery system. In one example, to enable efficient drainage of the electrolyte from the cell stacks during operation of the redox flow battery system in a stand-by mode, a gravity drainage subsystem may be incorporated into the redox flow battery system. The gravity drainage subsystem may include at least one electrolyte sump tank for receiving electrolyte drained from the cell stacks, as well as one or more three-way valves to control electrolyte flow. Examples of redox flow battery system configurations utilizing the electrolyte sump tank are illustrated in FIGS. 3 and 4. An example of a method for operating the redox flow battery system with the electrolyte sump tank and the one or more three-way valves is show in FIG. 5 and examples of variations in parameters while the redox flow battery system is adjusted between different operating modes are illustrated in FIG. 6.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

Fe²⁺+2e⁻↔Fe⁰−0.44 V(negative electrode) (1)

Fe²⁺↔Fe³⁺+e⁻+0.77 V(positive electrode) (2)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolve back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, where the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18. It may be appreciated that increasing a concentration of iron in the positive and negative electrolytes may increase a capacity of the IFB system without increasing the volume of electrolyte. In this way, an energy density of the IFB system may be increased.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems. Addition of supporting salts to the electrolytes as described below may allow for an increased iron concentration in the electrolyte solution. Supporting salts may be salts which increase a conductivity of the electrolyte solution and further aid in a stability of the redox active salts (e.g., FeCl₂) but are not oxidized or reduced during the operation of the redox flow battery.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe²⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, the separator 24, and the positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may also include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions.

FIG. 1 further illustrates a fill height 112 of the multi-chambered electrolyte storage tank 110, which may indicate a liquid level in each tank compartment. FIG. 1 also shows a gas headspace 90 located above the fill height 112 of the negative electrolyte chamber 50, and a gas headspace 92 located above the fill height 112 of the positive electrolyte chamber 52. The gas headspace 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas headspaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110, e.g., integrated such that both the negative and the positive electrolytes are stored within a common tank but in separate chambers, may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas headspaces 90 and 92 that fluidically couples the gas headspaces 90, 92 to one another. As such, the spillover hole 96 may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas headspaces 90 and 92 for directing H₂ gas to rebalancing reactors or cells 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together.

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location.

As further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 may be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, where acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. Herein, the power module 120 may also be referred to as a battery, e.g., a redox flow battery of the redox flow battery system 10. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

When the redox flow battery system 10 is not operating in the charge mode or the discharge mode, the system may be in a stand-by mode. During operation in the stand-by mode, the negative and positive electrolyte pumps 30, 32 may be deactivated and electrolyte flow through the system may be suspended. Draining of electrolyte from the redox flow battery cell 18, e.g., the negative electrolyte from the negative electrode compartment 20 and the positive electrolyte from the positive electrode compartment 22, may be desirable to mitigate degradation of battery cell components that may result from prolonged submergence in stagnant acidic solution. The electrolyte may be removed from the redox flow battery cell 18 by a gravity drainage subsystem 140, which may include an electrolyte sump tank 142, one or more three-way valves 144, and various passage and connections coupling the electrolyte sump tank 142 to the multi-chambered electrolyte storage tank 110 and the redox battery cell 18. The one or more three-way valves 144 may include a first three-way valve 144a and a second three-way valve 144b.

For example, the first three-way valve 144a may be positioned at a first fluid junction of the redox flow battery cell 18, the electrolyte sump tank 142, and the multi-chambered electrolyte storage tank 110 while the second three-way valve 144b may be positioned at a second fluid junction of the redox flow battery cell 18, the electrolyte sump tank 142, and the multi-chambered electrolyte storage tank 110, where the fluid junctions are intersections of electrolyte passages corresponding to the redox flow battery cell 18, the electrolyte sump tank 142, and the multi-chambered electrolyte storage tank 110. In some examples, each of the three-way valves 144 may instead be configured as two individual two-way valves actuated between open and closed states to provide analogous flow control to the three-way valves 144. The gravity drainage subsystem 140 may enable the electrolyte to be drained without relying on a large UPS as a backup power source during instances where power is unavailable or lost to the system. Further details of the gravity drainage subsystem are provided below, with reference to FIGS. 3-6.

Referring now to FIG. 2, it illustrates a side view of an example redox flow battery system layout 200 for the redox flow battery system 10 of FIG. 1. As such, components common to FIGS. 1 and 2 will not be re-introduced for brevity. Redox flow battery system 10 may be housed within a housing 202 that facilitates its long-distance transport and delivery. In some examples, the housing 202 can include a standard steel freight container or a freight trailer that can be transported via rail, truck or ship. The redox flow battery system layout 200 may include the integrated multi-chambered electrolyte storage tank 110 and one or more rebalancing reactors (e.g., rebalancing reactor 80) positioned at a first side of the housing 202, and a power module 210 and power control system (PCS) 288 at a second side of the housing 202.

Auxiliary components such as supports 206, as well as various piping 204, pumps 230, valves (not shown at FIG. 2), and the like may be included within the housing 202 (as further described above with reference to FIG. 1) for stabilizing and fluidly connecting the various components positioned therein. For example, one or more pumps 230 may be utilized to convey electrolyte from the integrated multi-chambered electrolyte storage tank 110 to one or more redox flow battery cell stacks 214 within the power module 210. Furthermore, additional pumps 230 may be utilized to return electrolyte from the power module 210 to the negative electrolyte chamber 50 or the positive electrolyte chamber 52 of the integrated multi-chambered electrolyte storage tank 110.

Power module 210 may include one or more redox flow battery cell stacks 214 electrically connected in parallel and/or in series. Each of the one or more redox flow battery cell stacks 214 may further include a plurality of redox flow battery cells, such as the redox flow battery cell 18 of FIG. 1, connected in parallel and/or series. In this way, power module 210 may be able to supply a range of current and/or voltages to external loads. The PCS 288 includes controller 88 of FIG. 1, as well as other electronics, for controlling and monitoring operation of the redox flow battery system 10. Furthermore, PCS 288 may regulate and monitor voltage supplied to external loads, as well as supplying current and/or voltage from external sources for charging of the power module 210. The PCS 288 may further regulate and control operation of the redox flow battery system 10 during an idle state or idle mode. The redox flow battery system 10 being in an idle state may occur when the power module 210 is not in a charge mode or a discharge mode.

As an example, the power module 210 may be in the charge mode when an external voltage or current is supplied to one or more redox flow battery cells 18 of the power module 210 resulting in reduction of electrolyte and plating of the reduced electrolyte at the bipolar plate 36 connected to the negative electrode(s) of the one or more redox flow battery cells 18. For the case of an IFB, ferrous ions may be reduced at the plating electrode(s) of one or more redox flow battery cells 18, thereby plating iron thereat during charging of the power module 210. As another example, the power module 210 may be in the discharge mode when voltage or current is supplied from one or more redox flow battery cells 18 of the power module 210 resulting in oxidation of plated metal at the negative electrode resulting in deplating (e.g., loss of metal) and solubilizing of the oxidized metal ions. For the case of an IFB, iron may be oxidized at the plating electrode of one or more redox flow battery cells 18, thereby solubilizing ferrous ions thereat during discharging of the power module 210.

As described above, during operation of the redox flow battery system 10 in a charge or discharge mode, electrolyte (e.g., both positive and negative electrolyte) may be circulated through the redox flow battery cell stacks 214. An electrolyte sump tank of a gravity drainage subsystem (such as the electrolyte sump tank 142 of the gravity drainage subsystem 140 of FIG. 1), although not depicted in FIG. 2, may be fluidically coupled to the redox flow battery cell stacks 214 and to the multi-chambered electrolyte storage tank 110 via various passages and three-way valves (e.g., the three-way valves 144 of FIG. 1). When operation of the redox flow battery system 10 is adjusted to a stand-by mode, the pumps 230 (and other pumps included in the redox flow battery system 10) may be deactivated and electrolyte circulation may be halted. In response to adjustment of the redox flow battery system 10, the redox flow battery cell stacks 214 may be automatically drained by actuation of the three-way valves to suitable positions to enable gravity-driven draining of the electrolyte from the redox flow battery cell stacks 214 to the electrolyte sump tank, which may be positioned vertically lower than the redox flow battery cell stacks 214.

As such, the electrolyte sump tank may be sized to receive a total volume of the electrolyte occupying the redox flow battery cell stacks 214 and passages of the redox flow battery system 10 when the redox flow battery system 10 is not operating in the charge or discharge mode. During charge or discharge, the electrolyte sump tank may be bypassed and remain empty until adjustment to the stand-by mode. Prior to return of the redox flow battery system 10 to the charge or discharge mode from the stand-by mode, the electrolyte sump tank may be drained and the electrolyte returned to the redox flow battery cell stacks 214. The electrolyte sump tank may thereby be prepared for subsequent adjustment to the stand-by mode.

In some examples, a size and volume of the electrolyte sump tank may be sufficiently large to be used exclusively as an electrolyte storage reservoir, allowing the multi-chambered electrolyte storage tank to be omitted. In such instances, electrolyte circulation through the redox flow battery system may be at least partially gravity-driven, including during operation of the system in the charge or discharge mode. For example, during operation in the charge or discharge mode, the electrolyte pumps (e.g., the negative and positive electrolyte pumps 30 and 32 of FIG. 1) may be activated to promote electrolyte flow into the redox flow battery cell and the electrolyte may drain out of the battery cell into the electrolyte sump tank based on gravity. By omitting the multi-chambered electrolyte storage tank, the redox flow battery system may be simplified and have a smaller footprint and a parasitic power of the redox flow battery system may be reduced to decreased power demand of the pumps. Additionally, there advantages to having a separate electrolyte sump tank, smaller than the multi-chambered electrolyte storage tank. A footprint of the redox flow battery system may be decreased when fitting a smaller tank vertically below (e.g., with respect to gravity) the redox flow battery cells. Further, electrolyte sump tank may not include partitions, and draining the redox flow battery cells into the electrolyte sump tank may mix the negative and positive electrolytes, which may be a desired action, based on the electrolyte health, whereas during operation (e.g., in charging mode or discharging mode) it may be desired to separate negative electrolyte from positive electrolyte in the multi-chambered electrolyte storage tank.

Incorporation of the gravity drainage subsystem into the redox flow battery system may be enabled by more than one arrangement. Regardless of the arrangement, the electrolyte sump tank may be positioned such that flow of the electrolyte from the cell stacks, as well as from rebalancing cells (RBCs), of the redox flow battery system to the electrolyte sump tank is driven by gravity. The cell stacks and the rebalancing cells may therefore be located above the electrolyte sump tank, with respect to a direction of gravity. Draining of the electrolyte from the cell stacks and the rebalancing cells may therefore be a passive process. Adjustment of the three-way valves may demand electrical power while electrolyte flows without providing electrical power to electrolyte pumps.

A first exemplary configuration of a redox flow battery system 300 having a gravity drainage subsystem 302 is depicted in FIG. 3. Hydrogen circulation is indicated in solid lines, which may flow between a headspace 306 of an electrolyte storage tank 308 (e.g., a gas-occupied volume above a fluid level 310 of the electrolyte storage tank 308) and a headspace of an electrolyte sump tank 320. By fluidically coupling the headspace of the electrolyte sump tank 320 to the headspace 306 of the electrolyte storage tank 308, generation of a vacuum in either tank may be mitigated.

In one example, the electrolyte storage tank 308 may be similarly configured as the multi-chambered electrolyte storage tank 110 of FIGS. 1 and 2 and the electrolyte sump tank 320 may be analogous to the electrolyte sump tank 142 of FIG. 1 (e.g., electrolyte storage tank 308 is a non-limiting example of the multi-chambered electrolyte storage tank 110 and electrolyte sump tank 320 is a non-limiting example of the electrolyte sump tank 142). Further, as described herein, flow of the electrolyte through the redox flow battery system 300 represents flow of both a positive and a negative electrolyte, which may be mixed during stand-by operation of the redox flow battery system 300, thereby allowing an electrolyte (which includes both the positive and negative electrolytes) to be rebalanced.

The electrolyte may be circulated through the redox flow battery system 300 by an electrolyte pump 316 during normal operation of the redox flow battery system 300, which includes operation in a charging or a discharging mode. In one example, the electrolyte pump 316 may be positioned at a similar height, e.g., vertical height with respect to a direction of gravity, as the electrolyte sump tank 320. It will be appreciated that while one electrolyte pump is depicted in FIG. 3 (and FIG. 4), the redox flow battery system 300 may include more than one electrolyte pump, which may be operated in a similar manner as described herein. The flow of the electrolyte during normal operation is indicated by a first set of dashed lines (see legend in FIG. 3 for normal flow), and a direction of flow is indicated by arrows 318. The electrolyte may be continuously circulated between the electrolyte storage tank 308 and cell stacks of a power module or battery 322 of the redox flow battery system 300 via the electrolyte pump 316.

The redox flow battery system 300 may further include a first three-way valve (TWV) 328 (e.g., a first valve), located proximate to a bottom of the electrolyte sump tank 320 and at a first fluid junction 327, and a second TWV 330 (e.g., a second valve) which may be located higher, e.g., relative to the direction of gravity, than the first TWV 328 and at second fluid junction 329. As an example, the second TWV 330 may be positioned above the electrolyte sump tank 320. The first and second TWVs 328, 330 may each be in a first position when the redox flow battery system 300 is operating in the charge or discharge mode. For example, when the first and second TWVs 328, 330 are in the first position, respectively, the electrolyte may be drawn from an outlet proximate to a bottom of the electrolyte storage tank 308, as indicated by arrows 318, through the first TWV 328, through the electrolyte pump 316, and into the battery 322 at an inlet port 332 of the battery 322. The electrolyte may flow out of the battery 322 at an outlet port 334 and through the second TWV 330 to an inlet of the electrolyte storage tank 308 at a top of the electrolyte storage tank 308. The first and second TWVs 328, 330, may therefore block electrolyte flow to the electrolyte sump tank 320 from the electrolyte storage tank 308 and the battery 322 when in the first position, respectively.

When operation of the redox flow battery system 300 is switched to the stand-by mode from either the charge mode or the discharge mode, or the redox flow battery system 300 is activated (e.g., turned on) but maintained in the stand-by mode, the first and second TWVs 328, 330 may be adjusted to a second position, respectively. The electrolyte pump 316 and, if present, a pump directing electrolyte flow to the RBCs may be deactivated. When the TWVs are each adjusted to the second position, the electrolyte may be drained from the battery 322 into the electrolyte sump tank 320, as indicated by arrows 336 and a third set of dashed lines (see legend in FIG. 3 for drain flow). The electrolyte sump tank 320 may be positioned vertically below the battery 322, with respect to the direction of gravity such that gravity may promote draining of the electrolyte in the battery 322 into the electrolyte sump tank 320.

For example, when the first TWV 328 is in the second position, the electrolyte may flow out of the inlet port 332, as indicated by arrows 336, through the deactivated electrolyte pump 316 (e.g., backwards through the electrolyte pump 316), through the first TWV 328 and into the electrolyte sump tank 320 via a port located proximate to a bottom of the electrolyte sump tank 320. The electrolyte may also flow out of the battery 322 through the outlet port 334, through the second TWV 330 (adjusted to the second position), and into a port located proximate to a top of the sump tank. When the redox flow battery system is in the stand-by mode, the first TWV 328 blocks flow between the electrolyte storage tank 308 and the battery 322 and directs the electrolyte to the bottom of the electrolyte sump tank 320. The second TWV 330 blocks flow between the battery 322 and the electrolyte storage tank 308 and directs the electrolyte to a headspace of the electrolyte sump tank 320.

When operation of the redox flow battery system is adjusted from the stand-by mode to normal operation (e.g., charge or discharge) the TWVs may be returned to the first position sequentially, e.g., staggered, as the pumps are activated. For example, the second TWV 330 may be adjusted to the first position, while maintaining the first TWV 328 in the second position. The electrolyte is thereby pumped out of the electrolyte sump tank 320 and through the first TWV 328 into the battery 322 via the inlet port 332. A fluid level of the electrolyte sump tank 320 may be monitored, e.g., by a sensor such as a level switch, until the electrolyte sump tank 320 is detected to be empty. The first TWV 328 may be adjusted to the first position when the electrolyte sump tank 320 is determined to be fully drained and normal operation of the redox flow battery system 300 may proceed.

A second exemplary configuration of a redox flow battery system 400 having a gravity drainage subsystem 402 is depicted in FIG. 4. The redox flow battery system 400 shares components in common with the redox flow battery system of FIG. 3 and, as such, the shared components will not be re-introduced for brevity. The electrolyte sump tank 320 is similarly arranged below the battery 322 and the electrolyte pump 316 is positioned at a similar height as the electrolyte sump tank 320. The first TWV 328 is located proximate to the bottom of the electrolyte sump tank 320 while the second TWV 330 is located vertically above the first TWV 328 and vertically above the electrolyte sump tank 320. In on example, the first TWV 328 may be aligned with a bottom outer surface of the electrolyte sump tank 320.

Hydrogen circulation is indicated by solid lines and flows between the headspace 306 of the electrolyte storage tank 308 and the headspace of the electrolyte sump tank 320. Electrolyte circulation corresponding to normal operation (e.g., charge/discharge) of the redox flow battery system 400 and to operation in a stand-by mode are shown in different sets of dashed lines (see legend of FIG. 4). An additional dashed line represents an electrolyte passage where a direction of electrolyte flow may alternate depending on an operating mode of the redox flow battery system 400 (e.g., Normal+drain in FIG. 4).

During normal operation of the redox flow battery system 400, the first and second TWVs 328, 330 may each be in the first position, as described above. A direction of electrolyte flow during normal operation is indicated by arrows 404. For example, the electrolyte may be pumped, via the electrolyte pump 316, from the outlet proximate to the bottom of the electrolyte storage tank, through the second TWV 330, bypassing the electrolyte sump tank 320, and into an inlet port 406 of the battery 322. The electrolyte may leave the battery 322 through an outlet port 408 and may pass through the first TWV 328 to be directed to an inlet at the top of the electrolyte storage tank 308 via the pump 316 and bypassing the electrolyte sump tank 320. In the first position, the TWVs may inhibit electrolyte flow between the battery 322 and the electrolyte sump tank 320. Further, flow may be continuous (e.g., the TWVs are open) between the battery 322 and the electrolyte pump 316. When adjusted to the second position, the TWVs may enable the flow of electrolyte to be continuous between the electrolyte sump tank 320 and the battery 322.

When the redox flow battery system 400 is operated in the stand-by mode and the electrolyte pump 316 and the RBC pump (when present) are deactivated, the first and second TWVs 328, 330 may be automatically adjusted to the second position, respectively. For example, flow of the electrolyte out of the battery 322 through the outlet port 408 may be blocked when the first TWV 328 is in the second position. The electrolyte in the electrolyte passages between the first TWV 328 and the electrolyte storage tank 308 may drain into the electrolyte sump tank 320, through the electrolyte pump 316 and the first TWV 328, as indicated by arrows 412. In other words, the electrolyte may flow through the electrolyte pump 316 in a backwards direction relative to arrows 404.

The electrolyte in the battery 322 may drain out of the battery 322, as driven by gravitational pull, from the inlet port 406, through the second TWV 330, and into the electrolyte sump tank 320 at the top of the electrolyte sump tank 320. In the second position, the second TWV 330 is adjusted such that the electrolyte storage tank 308 is not fluidically coupled to the battery 322, e.g., the second TWV 330 blocks flow of the electrolyte between the electrolyte storage tank 308 and the battery 322.

When normal operation of the redox flow battery system 400 is to be resumed, the TWVs may be adjusted to the first position, respectively, but in a staggered, sequential manner, as described above. For example, the second TWV 330 may be adjusted to the first position but the first TWV 328 may be maintained in the second position while the electrolyte pump 316 is activated. The electrolyte may be pumped out of the electrolyte sump tank 320 through the first TWV 328 and into the electrolyte storage tank 308, at an inlet at the top of the electrolyte storage tank 308. When the electrolyte sump tank 320 is detected to be empty, such as by the level switch, the first TWV 328 may be adjusted to the first position, thereby promoting circulation of the electrolyte through the battery 322.

The TWVs may be electrically actuated valves, in one example, which may be controlled by open/close actuators. The actuators may be supported, during instances of system power loss, by a small UPS. During loss of system power, the small UPS may provide sufficient power to turn the TWVs from the first position to the second position, respectively, to allow the battery to be drained of electrolyte. As another example, the TWVs may instead be configured with self-returning actuators that are energized during normal operation of the redox flow battery system. In other words, the TWVs are maintained in the first position, respectively, when power is supplied to the self-returning actuators. When power supply to the TWVs is terminated, e.g., during an unexpected loss of system power or during operation in the stand-by mode, the TWVs may be de-energized and automatically adjusted to the second position, allowing the battery to be drained of electrolyte. Although the self-returning actuators may increase parasitic power losses of the redox flow battery system compared to use of the UPS, the self-returning actuators may be more robust than the UPS. For example, if the UPS becomes degraded, it is unable to deliver power to the TWVs.

As described above, in some examples, two actuated valves may be used in place of each of the TWVs. For example, as shown in FIG. 4 proximate to the first TWV 328, the first TWV 328 may be substituted by a first set of actuated valves 450, including a first actuated valve 450a and a second actuated valve 450b. The first actuated valve 450a may be positioned in a path of electrolyte flow between the battery 322 and the electrolyte pump 316 and the second actuated valve 450b may be positioned in a path of electrolyte flow between the battery 322 and the electrolyte sump tank 320. Said another way, the first actuated valve 450a may be positioned in a first fluid conduit 403, the first fluid conduit 403 coupling the electrolyte sump tank 320 to the electrolyte pump 316. Further the second actuated valve 450b may be positioned in a second fluid conduit 405, the second fluid conduit 405 fluidly coupling the first fluid conduit 403 to the outlet port 408 of the battery 322. The first set of actuated valves 450 are therefore positioned on either side of a passage junction between the battery 322, the electrolyte sump tank 320, and the electrolyte pump 316. Actuation of the first set of actuated valves 450 between an open and a closed position may be alternated between the first actuated valve 450a and second actuated valve 450b to control a direction of electrolyte flow, similar to control of the first TWV 328, according to the operating mode of the redox flow battery system 400. Electrolyte may be directed from the inlet port 406 of the battery 322 to the electrolyte sump tank 320 when the first actuated valve 450a is in an open position and the second actuated valve 450b is in a closed position. Electrolyte may be directed from the outlet port 408 of the battery 322 to the electrolyte storage tank 308 when first actuated valve 450a is in a closed position and second actuated valve 450b is in an open position.

Similarly, the second TWV 330 may be substituted by a second set of actuated valves 460, including a third actuated valve 460a and a fourth actuated valve 460b. The third actuated valve 460a may be positioned in a path of electrolyte flow between the battery 322 and the electrolyte storage tank 308. The fourth actuated valve 460b may be positioned in a path of electrolyte flow between the electrolyte storage tank 308 and the electrolyte sump tank 320. Said another way, the third actuated valve 460a may be positioned in a third fluid conduit 407, the third fluid conduit 407 fluidly coupling the electrolyte storage tank 308 to an inlet port 406 of the battery 322. Further the fourth actuated valve 460b may positioned in a fourth fluid conduit, the fourth fluid conduit 409 fluidly coupling the third fluid conduit 407 to the electrolyte sump tank 320. The second set of actuated valves 460 may be actuated to control a direction of electrolyte flow, similar to second TWV 330, according to the operating mode of the redox flow battery system 400. Electrolyte may be directed from the inlet port 406 of the battery 322 to the electrolyte sump tank 320 when third actuated valve 460a is in a closed position and fourth actuated valve 460b is in an open position. Electrolyte may be directed from the outlet port 408 of the battery 322 to the electrolyte storage tank 308 when third actuated valve 460a is in the open position and fourth actuated valve 460b is in the closed position.

An example of a method 500 for operating a redox flow battery system having a gravity drainage subsystem is shown in FIG. 5. In one example, the redox flow battery system may be any of the redox flow battery systems of FIG. 1, 3, or 4, configured with an electrolyte sump tank located below a battery and with TWVs controlling flow of electrolyte to the electrolyte sump tank. In examples where a set of actuated valves, e.g., the first set of actuated valves 450 and the second set of actuated valves 460 of FIG. 4, are used in place of each of the TWVs, the set of actuated valves may be controlled in an analogous manner as described below. Instructions for carrying out method 500 may be executed by a controller, such as the controller 88 of FIG. 1, based on instructions stored on a memory of the controller and in conjunction with signals received from sensors of the redox flow battery system, such as the sensors described above with reference to FIG. 1. The controller may employ actuators of the redox flow battery system, such as electrolyte pumps and the TWVs, to adjust its operation, according to the strategies described below.

At 502, the method includes confirming a current operating mode of the redox flow battery system. For example, the redox flow battery system may be currently undergoing a normal mode of operation which may include a charge mode or a discharge mode. When operating in the charge mode, the redox flow battery system may be electrically coupled to a voltage source that drives current flow across a positive electrode and a negative electrode of each battery cell of the battery to facilitate plating of iron at the negative electrode. Conversely, when the redox flow battery system is operating in the discharge mode, the redox flow battery system may be coupled to an electrical load that draws current from the system, causing the iron at the negative electrode to deplate. Alternatively, the redox flow battery system may be operating in a stand-by mode during which the electrolyte pumps may be deactivated and electrolyte flow may be halted.

The operating mode of the redox flow battery system may be confirmed based on signals from the electrolyte pumps, and sensors monitoring various parameters of the redox flow battery system. For example, determination that the electrolyte pumps are actively pumping the electrolyte may confirm whether the redox battery system is operating in the normal mode of operation or in the stand-by mode, and monitoring of the battery SOC may indicate whether the redox flow battery system is charging or discharging.

At 504, the method includes determining if a request for operation in the stand-by mode is received. The request may be identified based on, for example, operator input at a user interface of the controller. If the request for stand-by operation is not received, the method proceeds to 506 to continue operating the redox flow battery system in the current operating mode. The method returns to the start. In some examples, the redox flow battery system may already be operating in the stand-by mode and the method may similarly return to the start.

If the request for stand-by operation is received, the method continues to 508 to deactivate the electrolyte pumps. For example, the electrolyte pumps may be switched to an off mode where the electrolyte pumps are no longer receiving power and electrolyte circulation through the redox flow battery system is halted. At 510, method 500 includes adjusting positions of the TWVs. In one example, each of the TWVs may be in a first position, prior to receiving the request for stand-by operation. In the first position, as described above with reference to FIGS. 3 and 4, the electrolyte sump tank may be bypassed by the flow of the electrolyte and the electrolyte may be circulated between the electrolyte storage tank and the battery, as well as through rebalancing cells. Upon receiving the request for stand-by operation, the TWVs may be adjusted to a second position, respectively. In the second position, at least one of the TWVs may be opened to the electrolyte sump tank, providing a continuous flow path between the battery and the electrolyte sump tank. In other words, the battery and the electrolyte sump tank are fluidically coupled when at least one of the TWVs are adjusted to the second position. The electrolyte in the battery may drain down to the electrolyte sump tank due to gravitational pull, without relying on any additional devices, such as additional pumps. It will be noted that the adjustment of the positions of the TWVs at 510 may occur concurrent with deactivation of the electrolyte pumps at 508, in one example.

At 512, the method includes determining if a change in the operating mode of redox flow battery system is requested. For example, the request may be indicated by user input, by activation of the electrolyte pumps (based on operator input or automatic activation based on sensor input) and/or coupling of the redox flow battery system to a voltage source for charging, or to an electrical load for discharging. If the request for the change in the operating mode is not received, the method returns to 508 to maintain the redox flow battery system in the stand-by mode, with the electrolyte pumps deactivated and the TWVs in the second position. If the request for the change in the operating mode is received, the method continues to 514 and includes adjusting a position of one of the TWVs, e.g., an upper TWV of the TWVs.

The upper TWV may be located above the electrolyte sump tank, e.g., the TWV 330 of FIGS. 3 and 4. Adjusting the position of the upper TWV may include switching the upper TWV to the first position, to bypass the electrolyte sump tank and direct flow between the electrolyte storage tank and the battery. A lower TWV of the TWVs, however, may remain in the second position and open to the electrolyte sump tank while the electrolyte pumps are activated at 516. One or more RBC pumps may also be turned on. The lower TWV may be located proximate to a bottom of the electrolyte sump tank and positioned lower, with respect to the direction of gravity, than the upper TWV. By activating the electrolyte pumps while the lower TWV is in the second position, the electrolyte may be pumped out of the electrolyte sump tank, thereby emptying the electrolyte sump tank to prepare the electrolyte sump tank for a future switch to the stand-by mode.

At 518, the method includes confirming if the electrolyte sump tank is empty. For example, an electrolyte level in the electrolyte sump tank may be determined based on a signal from a level switch. If the electrolyte sump tank is not empty, the method returns to 514 to maintain the first TWV in the first position, the second TWV in the second position, and the electrolyte pumps on. If the electrolyte sump tank is confirmed to be empty, the method proceeds to 520 to adjust the position of the second TWV to the first position. The electrolyte sump tank is bypassed by the flow of the electrolyte at of the TWVs and the electrolyte is circulated between the electrolyte storage tank, the battery, and rebalancing cells. The method returns to the start.

Examples of variations in operating parameters of a redox flow battery system during adjustment of the system to different operating modes is depicted in FIG. 6 in a graph 600. In one example, the redox flow battery system may be any of the redox flow battery systems of FIGS. 1, 3, and 4, having a gravity drainage subsystem with an electrolyte sump tank and two TWVs. The two TWVs includes an upper TWV, e.g., located above the electrolyte sump tank (such as the second TWV 330 of FIGS. 3 and 4), and a lower TWV, e.g., located near a bottom of the electrolyte sump tank (such as the first TWV 328 of FIGS. 3 and 4). Electrolyte circulation during normal operation of the redox flow battery system (e.g., in a charge or discharge mode) may be driven by electrolyte pumps.

Graph 600 includes a first plot 602, representing a status of the electrolyte pumps, a second plot 604, representing a position of the upper TWV, a third plot 606, representing a position of the lower TWV, a fourth plot 608 depicting a fluid level in the electrolyte sump tank, and a fifth plot 610 indicating a fluid volume (e.g., electrolyte volume) within the battery. The first plot 602 varies between on and off statuses along the y-axis, the second and third plots 604, 606 shows adjustment between a first position and a second position along the y-axis, and the fourth plot 608 is variable between an empty fill level and a full fill level along the y-axis. Fluid volume increase upwards along the y-axis for the fifth plot 610. For the TWVs (e.g., the second and third plots 604, 606), the first position blocks electrolyte flow to the electrolyte sump tank, while allowing electrolyte circulation between an electrolyte storage tank and battery cell stacks of the redox flow battery system and the second position opens flow to the electrolyte sump tank. Time is shown along the x-axis of graph 600 and events of significance are indicated.

At t0, the redox flow battery system is operating in a normal mode, e.g., charging or discharging, and the electrolyte pumps are on. The upper and lower TWVs are in the first position, causing the electrolyte flow to bypass the electrolyte sump tank. The electrolyte sump tank is empty while the battery is relatively full of electrolyte.

At t1, the redox flow battery system is adjusted to a stand-by mode. The electrolyte pumps are turned off and the TWVs are adjusted to the second position to allow the electrolyte to drain, as compelled by gravity, into the electrolyte sump tank. The fluid level of the electrolyte sump tank rises, reaching a maximum capacity between t1 and t2, while the fluid volume of the battery becomes empty between t1 and t2.

At t2, the redox flow battery system is returned to the normal operating mode. The electrolyte pumps are activated and the upper TWV is adjusted to the first position. The lower TWV is maintained in the second position, allowing the electrolyte to be pumped out of the electrolyte sump tank and returned to the battery via the electrolyte tank. As a result, the fluid level in the electrolyte sump tank decreases until the electrolyte sump tank is empty at t3. After t3, the fluid volume in the battery increases, the TWVs are each maintained in the first position, and the electrolyte sump tank remains empty.

In this way, degradation of battery components may be circumvented during operation of a redox flow battery system in a stand-by mode during which electrolyte circulation is suspended. The redox flow battery system may include an electrolyte sump tank, which may be an electrolyte storage reservoir with a volume able to receive an amount of electrolyte in the battery cell stacks, as well as the electrolyte maintained in fluid passages of the redox flow battery system. The electrolyte sump tank may be positioned vertically below, e.g., with respect to a direction of gravity, the battery. The electrolyte sump tank may be incorporated in a gravity drainage subsystem which may further include one or more three-way valves to control flow of electrolyte to the electrolyte sump tank. During charging or discharging of the redox flow battery system the electrolyte sump tank may be bypassed by the flow of the electrolyte due to a position of the three-way valves. When operation of the redox flow battery system is adjusted to the stand-by mode during which electrolyte pumps of the system are deactivated, the three-way valves may be actuated to a different position to allow the electrolyte in the battery cell stacks to be drained, based on gravity, into the electrolyte sump tank without demanding use of additional mechanisms or drawing power to drive electrolyte flow. Submerging of the battery in stagnant electrolyte is thereby precluded. Upon subsequent return of operation to a charge of discharge mode, adjustment of the three-way valves to resume electrolyte circulation between a main electrolyte storage tank and the battery cell stacks may be staggered to allow the electrolyte sump tank to be drained. As a result, a useful life of the battery components is prolonged without relying on a large UPS in events of system power loss.

The disclosure provides support for a redox flow battery system, comprising: an electrolyte sump tank positioned below cell stacks of the redox flow battery system, the electrolyte sump tank configured to receive electrolyte from the cell stacks during operation of the redox flow battery system in a stand-by mode, and three-way valves arranged in a flow path of the electrolyte between the cell stacks and the electrolyte sump tank to control a flow of the electrolyte to the electrolyte sump tank. In a first example of the system, the electrolyte sump tank is sized to store a volume of electrolyte in the cell stacks and in electrolyte passages of the redox flow battery system. In a second example of the system, optionally including the first example, the electrolyte is drained into the electrolyte sump tank based on gravity when the redox flow battery system is adjusted to the stand-by mode from one of a charge mode or a discharge mode. In a third example of the system, optionally including one or both of the first and second examples, the three-way valves are adjustable between a first position and a second position, and wherein when the three-way valves are in the first position, the electrolyte is circulated between the cell stacks and an electrolyte storage tank and when the three-way valves are in the second position, the electrolyte is drained from the cell stacks into the electrolyte sump tank. In a fourth example of the system, optionally including one or more or each of the first through third examples, the three-way valves are in the second position when the redox flow battery system is operating in the stand-by mode. In a fifth example of the system, optionally including one or more or each of the first through fourth examples, circulation of the electrolyte is driven by electrolyte pumps, and wherein the electrolyte pumps are deactivated when the three-way valves are in the second position. In a sixth example of the system, optionally including one or more or each of the first through fifth examples, the three-way valves include a first three-way valve located proximate to a bottom of the electrolyte sump tank and a second three-way valve located above the electrolyte sump tank. In a seventh example of the system, optionally including one or more or each of the first through sixth examples in response to adjustment of operation of the redox flow battery system to a charge mode or a discharge mode from the stand-by mode, the second three-way valve is adjusted to the first position before the first three-way valve, and wherein the first three-way valve is maintained in the second position until the electrolyte sump tank is drained of the electrolyte, and wherein the first three-way valve is adjusted to the first position when the electrolyte sump tank is empty.

The disclosure also provides support for a method for operating a redox flow battery system, comprising: responsive to operation of the redox flow battery system in a stand-by mode: adjusting a first valve and a second valve to a first position, respectively, to drain electrolyte from cell stacks of the redox flow battery system into an electrolyte sump tank located below the cell stacks, and responsive to a change in operation of the redox flow battery system from the stand-by mode to a charge mode or a discharge mode: adjusting the first valve and the second valve to a second position, respectively, to block flow of the electrolyte to the electrolyte sump tank, wherein the adjusting of the first valve and the second valve to the second position is staggered to drain the electrolyte sump tank. In a first example of the method, the method further comprises: responsive to operation of the redox flow battery system in the stand-by mode, deactivating electrolyte pumps of the redox flow battery system. In a second example of the method, optionally including the first example, adjusting the first valve and the second valve to the first position, fluidically couples the cell stacks to the electrolyte sump tank, and wherein the electrolyte is compelled to drain into the electrolyte sump tank from the cell stacks based on gravity and without use of any additional devices. In a third example of the method, optionally including one or both of the first and second examples, the method further comprises: responsive to the change in operation of the redox flow battery system from the stand-by mode to the charge mode or the discharge mode, activating electrolyte pumps of the redox flow battery system to circulate the electrolyte through the redox flow battery system. In a fourth example of the method, optionally including one or more or each of the first through third examples, adjusting the first valve and the second valve to the second position, respectively, includes adjusting the first valve, the first valve located above the electrolyte sump tank, to the first position to block the flow of the electrolyte between the cell stacks and the electrolyte sump tank at the first valve while maintaining the second valve in the first position. In a fifth example of the method, optionally including one or more or each of the first through fourth examples, the second valve is adjusted to the second position after the electrolyte sump tank is drained of the electrolyte, and wherein the electrolyte sump tank is drained via pumping of the electrolyte by the electrolyte pumps.

The disclosure also provides support for a method for operating a redox flow battery system, comprising: responsive to operation of the redox flow battery system in a stand-by mode: fluidically coupling an inlet of a battery of the redox flow battery system to an electrolyte sump tank positioned vertically below the battery while blocking flow of an electrolyte between an outlet of the battery and an electrolyte storage tank, and responsive to a change in operation of the redox flow battery system to a charge mode or a discharge mode: fluidically coupling the outlet of the battery to the electrolyte storage tank while blocking flow of the electrolyte between the inlet of the battery and the electrolyte sump tank. In a first example of the method, fluidically coupling the inlet of the battery to the electrolyte sump tank includes adjusting a position of a first three-way valve to fluidically couple the electrolyte sump tank to the inlet and adjusting a position of a second three-way valve to fluidically decouple the electrolyte storage tank from the inlet, and wherein the first three-way valve is positioned at a first fluid junction of the battery, the electrolyte storage tank, and the electrolyte sump tank, and wherein the second three-way valve is positioned at a second fluid junction of the battery, the electrolyte storage tank, and the electrolyte sump tank. In a second example of the method, optionally including the first example, fluidically coupling the outlet of the battery to the electrolyte storage tank includes adjusting the position of first three-way valve to fluidically decouple the electrolyte sump tank from the inlet and adjusting the position of the second three-way valve to fluidically couple the outlet to the electrolyte storage tank. In a third example of the method, optionally including one or both of the first and second examples, fluidically coupling the inlet of the battery to the electrolyte sump tank includes adjusting a first actuated valve of a first set of actuated valves to an open position and a second actuated valve of the first set of actuated valves to a closed position, the first set of actuated valves arranged proximate to a first fluid junction of the battery, the electrolyte storage tank, and the electrolyte sump tank. In a fourth example of the method, optionally including one or more or each of the first through third examples, fluidically coupling the inlet of the battery to the electrolyte sump tank further includes adjusting a third actuated valve of a second set of actuated valves to a closed position and a fourth actuated valve of the second set of actuated valves to an open position, the second set of actuated valves arranged proximate to a second fluid junction of the battery, the electrolyte storage tank, and the electrolyte sump tank. In a fifth example of the method, optionally including one or more or each of the first through fourth examples, fluidically coupling the outlet of the battery to the electrolyte storage tank includes adjusting the first actuated valve of the first set of actuated valves to a closed position and the second actuated valve of the first set of actuated valves to an open position, and adjusting the third actuated valve of the second set of actuated valves to an open position and the fourth actuated valve of the second set of actuated valves to a closed position.

In an alternate embodiment, the disclosure also provides support for a redox flow battery system, comprising: a battery, an electrolyte storage tank configured to store electrolyte, the electrolyte configured to circulate between the battery and the electrolyte storage tank, and a gravity drainage subsystem including an electrolyte sump tank arranged below the battery and three-way valves controlling flow of the electrolyte between the electrolyte sump tank and the battery, the gravity drainage subsystem configured to drain the electrolyte from the battery when the electrolyte is not circulated through the redox flow battery system. In a first example of the system, a first gas headspace of the electrolyte sump tank is fluidically coupled to a second gas headspace of the electrolyte storage tank. In a second example of the system, optionally including the first example, the three-way valves are configured to be electrically actuated between a first position and a second position, the first position configured to bypass electrolyte flow to the electrolyte sump tank and the second position configured to enable the electrolyte flow to the electrolyte sump tank, or wherein the three-way valves are configured with self-returning actuators, that when energized, cause the three-way valves to be in the first position and when de-energized, cause the three-way valves to be in the second position.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A redox flow battery system, comprising:
an electrolyte sump tank positioned below cell stacks of the redox flow battery system, the electrolyte sump tank configured to receive electrolyte from the cell stacks during operation of the redox flow battery system in a stand-by mode; and
three-way valves arranged in a flow path of the electrolyte between the cell stacks and the electrolyte sump tank to control a flow of the electrolyte to the electrolyte sump tank.

2. The redox flow battery system of claim 1, wherein the electrolyte sump tank is sized to store a volume of electrolyte in the cell stacks and in electrolyte passages of the redox flow battery system.

3. The redox flow battery system of claim 1, wherein the electrolyte is drained into the electrolyte sump tank based on gravity when the redox flow battery system is adjusted to the stand-by mode from one of a charge mode or a discharge mode.

4. The redox flow battery system of claim 1, wherein the three-way valves are adjustable between a first position and a second position, and wherein when the three-way valves are in the first position, the electrolyte is circulated between the cell stacks and an electrolyte storage tank and when the three-way valves are in the second position, the electrolyte is drained from the cell stacks into the electrolyte sump tank.

5. The redox flow battery system of claim 4, wherein the three-way valves are in the second position when the redox flow battery system is operating in the stand-by mode.

6. The redox flow battery system of claim 5, wherein circulation of the electrolyte is driven by electrolyte pumps, and wherein the electrolyte pumps are deactivated when the three-way valves are in the second position.

7. The redox flow battery system of claim 6, wherein the three-way valves include a first three-way valve located proximate to a bottom of the electrolyte sump tank and a second three-way valve located above the electrolyte sump tank.

8. The redox flow battery system of claim 7, wherein, in response to adjustment of operation of the redox flow battery system to a charge mode or a discharge mode from the stand-by mode, the second three-way valve is adjusted to the first position before the first three-way valve, and wherein the first three-way valve is maintained in the second position until the electrolyte sump tank is drained of the electrolyte, and wherein the first three-way valve is adjusted to the first position when the electrolyte sump tank is empty.

9. A method for operating a redox flow battery system, comprising:
responsive to operation of the redox flow battery system in a stand-by mode:
adjusting a first valve and a second valve to a first position, respectively, to drain electrolyte from cell stacks of the redox flow battery system into an electrolyte sump tank located below the cell stacks; and
responsive to a change in operation of the redox flow battery system from the stand-by mode to a charge mode or a discharge mode:
adjusting the first valve and the second valve to a second position, respectively, to block flow of the electrolyte to the electrolyte sump tank, wherein the adjusting of the first valve and the second valve to the second position is staggered to drain the electrolyte sump tank.

10. The method of claim 9, further comprising, responsive to operation of the redox flow battery system in the stand-by mode, deactivating electrolyte pumps of the redox flow battery system.

11. The method of claim 9, wherein adjusting the first valve and the second valve to the first position, fluidically couples the cell stacks to the electrolyte sump tank, and wherein the electrolyte is compelled to drain into the electrolyte sump tank from the cell stacks based on gravity and without use of any additional devices.

12. The method of claim 9, further comprising, responsive to the change in operation of the redox flow battery system from the stand-by mode to the charge mode or the discharge mode, activating electrolyte pumps of the redox flow battery system to circulate the electrolyte through the redox flow battery system.

13. The method of claim 12, wherein adjusting the first valve and the second valve to the second position, respectively, includes adjusting the first valve, the first valve located above the electrolyte sump tank, to the first position to block the flow of the electrolyte between the cell stacks and the electrolyte sump tank at the first valve while maintaining the second valve in the first position.

14. The method of claim 13, wherein the second valve is adjusted to the second position after the electrolyte sump tank is drained of the electrolyte, and wherein the electrolyte sump tank is drained via pumping of the electrolyte by the electrolyte pumps.

15. A method for operating a redox flow battery system, comprising:
responsive to operation of the redox flow battery system in a stand-by mode:
fluidically coupling an inlet of a battery of the redox flow battery system to an electrolyte sump tank positioned vertically below the battery while blocking flow of an electrolyte between an outlet of the battery and an electrolyte storage tank; and
responsive to a change in operation of the redox flow battery system to a charge mode or a discharge mode:
fluidically coupling the outlet of the battery to the electrolyte storage tank while blocking flow of the electrolyte between the inlet of the battery and the electrolyte sump tank.

16. The method of claim 15, wherein fluidically coupling the inlet of the battery to the electrolyte sump tank includes adjusting a position of a first three-way valve to fluidically couple the electrolyte sump tank to the inlet and adjusting a position of a second three-way valve to fluidically decouple the electrolyte storage tank from the inlet, and wherein the first three-way valve is positioned at a first fluid junction of the battery, the electrolyte storage tank, and the electrolyte sump tank, and wherein the second three-way valve is positioned at a second fluid junction of the battery, the electrolyte storage tank, and the electrolyte sump tank.

17. The method of claim 16, wherein fluidically coupling the outlet of the battery to the electrolyte storage tank includes adjusting the position of first three-way valve to fluidically decouple the electrolyte sump tank from the inlet and adjusting the position of the second three-way valve to fluidically couple the outlet to the electrolyte storage tank.

18. The method of claim 15, wherein fluidically coupling the inlet of the battery to the electrolyte sump tank includes adjusting a first actuated valve of a first set of actuated valves to an open position and a second actuated valve of the first set of actuated valves to a closed position, the first set of actuated valves arranged proximate to a first fluid junction of the battery, the electrolyte storage tank, and the electrolyte sump tank.

19. The method of claim 18, wherein fluidically coupling the inlet of the battery to the electrolyte sump tank further includes adjusting a third actuated valve of a second set of actuated valves to a closed position and a fourth actuated valve of the second set of actuated valves to an open position, the second set of actuated valves arranged proximate to a second fluid junction of the battery, the electrolyte storage tank, and the electrolyte sump tank.

20. The method of claim 19, wherein fluidically coupling the outlet of the battery to the electrolyte storage tank includes adjusting the first actuated valve of the first set of actuated valves to a closed position and the second actuated valve of the first set of actuated valves to an open position, and adjusting the third actuated valve of the second set of actuated valves to an open position and the fourth actuated valve of the second set of actuated valves to a closed position.
